(19) United States
(12) Patent Application Publication
(10) Pub. No.: US 2012/0171462 A1
(43) Pub. Date: Jul. 5, 2012

(54) METHOD AND DEVICE FOR RAPIDLY DRYING WARE SHELL AND WARE SHELL

(76) Inventor: Yuchi Tsai, Dongguan City (CN)

(21) Appl. No.: 13/395,319

(22) PCT Filed: Oct. 30, 2009
(86) PCT No.: PCT/CN2009/074709

§ 371 Date: Mar. 9, 2012

(30) Foreign Application Priority Data
Sep. 15, 2009 (CN) 200910172987.4

(51) Int. Cl. B32B 3/26; F26B 21/06; F26B 5/04

(52) U.S. Cl. 428/304.4; 34/406; 34/73; 34/76; 34/74

(57) ABSTRACT

A method and a device for rapidly drying ware shell, and a ware shell, are provided, in the field of precision casting technology. Conventionally, the ware shell drying process fails to ensure high quality of a ware shell and rapid drying simultaneously when the ware shell has a complex structure. The method includes the following steps: a. putting a ware shell to be dried in a sealed chamber; b. vacuuming the sealed chamber under the premise condition of controlling the ware shell in a constant temperature state, and cooling the gas in the sealed chamber in a predetermined time period to condense the moisture in the sealed chamber; c. vacuum injecting gas to the sealed vacuum chamber to make the chamber return to normal atmosphere pressure; d. determining whether the ware shell is dry. If result is YES, then end, otherwise back to step b.

### FIELD OF THE INVENTION

This invention relates to the precision casting technology, in particular, to a method and device for rapid drying ware shell and ware shell.

### BACKGROUND OF THE INVENTION

Precision casting is a casting method contrastive to the traditional casting technology, resulting in relatively accurate shapes and higher casting precisions. Precision casting process is as follows: first, making a wax pattern consistent with the product to be cast in size and shape; then, making a ware shell on the surface of the wax pattern, and dewaxing the ware shell (melting and removing the wax pattern inside); and finally, casting metal material into the dewaxed ware shell, and breaking and removing the ware shell after the metal material is cooled down and solidified, so as to obtain the required product.

In this process, making a ware shell is of great importance, which determines the quality of castings. At present, shell molding process is usually used for making ware shells, to be more specific, water-soluble silica sol shell molding process. This method is to prepare different slurries and sands with refractory materials, then apply one layer of slurry on the surface of the wax pattern, followed by one layer of sand and repeat this process to make a ware shell with the required thickness. Therefore, the ware shell may be structurally divided into surface layer, transition layer (the 2nd layer), supporting layer (back layer) and sealing layer, of which, there is only one surface layer, one transition layer and one sealing layer, and several supporting layers.

As the silica sol is reinforced by the dehydration and concentration process of the gel, in the process of making ware shells with water-soluble silica sol, an important processing step is to dry all layers of the ware shell.

The traditional drying method is to place a ware shell under constant temperature and humidity to let it dry naturally. The ware shell made in this way is of good quality, but it takes a long time. For a common ware shell of 6-8 layers, it takes about 8˜24 hours to dry each layer, and about one week to complete the whole work. Long process determines low production efficiency.

For the rapid drying of the ware shell, two new drying methods are developed and used:

Method I: dehumidifying the ware shell by forced blower to make it rapidly dried at a wind speed of 2˜12 m/s, and controlling the surface temperature of the ware shell under room temperature. This method improves the drying efficiency, only taking 6 hours to completely dry a 6-layer ware shell, but when the castings have a complex structure with holes, differences arise between windward and leeward sides during air blowing, and the wind speed inside the holes is far smaller than that on surface, which may result in excessive and insufficient dryings, and uneven drying would influence the quality of the ware shell.
Method II: covering the ware shell with porous powerful hygroscopic materials to rapidly absorb the moisture in the ware shell by means of the capillary phenomenon. This method can also improve the drying speed of ware shell, but it is required to completely remove the hygroscopic materials on the surface of ware shell before moving to the next step—immersion into slurry. Furthermore, when the castings have a complex structure with holes, it is not easy to embed the hygroscopic materials into the holes, so it is impossible to successfully complete the work.

It can be concluded that the current ware shell drying methods can't ensure high quality of a ware shell and rapid drying simultaneously when the ware shell has a complex structure.

### SUMMARY OF THE INVENTION

This invention provides a rapid drying method and device for ware shell, which is able to ensure the quality of a ware shell and realize the rapid drying of the ware shell simultaneously when the ware shell has a complex structure.

To achieve the above-mentioned purposes, the present invention adopts the following technical proposal:

A rapid drying method for ware shell, comprising the following steps:

a. putting a ware shell to be dried in a sealed chamber;
b. vacuuming the sealed chamber under the premise condition of controlling the ware shell in a constant temperature state, and cooling the gas in the sealed chamber in a predetermined time period to condensate the moisture in the sealed chamber;
c. vacuum injecting gas to the sealed vacuum chamber to make the chamber return to normal atmosphere pressure;
d. determining whether the ware shell is dry. If result is YES, then end, otherwise back to step b.

Optimally, when the surface layer of the ware shell is dried, the vacuum degree of the sealed chamber in step b is 650˜550 mmHg.

Optimally, when the transition layer of the ware shell is dried, the vacuum degree of the sealed chamber in step b is 530˜430 mmHg.

Optimally, when the supporting layer of the ware shell is dried, the vacuum degree of the sealed chamber in step b is 430˜330 mmHg.

Optimally, when the sealing layer of the ware shell is dried, the vacuum degree of the sealed chamber in step b is 430˜330 mmHg.

A rapid drying device for ware shell, comprising:

a sealed chamber, which is used for accommodating the ware shell to be dried, and comprises a chamber body equipped with a sealing door and an air inlet;
a heating device, which is for controlling the ware shell under constant temperature;
a vacuum device, which is connected with the sealed chamber for vacuuming the sealed chamber; and
a cooling and condensing device, which is for cooling part of gas in the sealed chamber to condense the moisture in the sealed chamber.

Optimally, the cooling and condensing device comprises a compressor, a condenser, an evaporator, a low-pressure regulating valve and an expansion valve. The compressor, the condenser, the low-pressure regulating valve and the expansion valve are all arranged outside the sealed chamber, while the evaporator is arranged inside the sealed chamber, wherein,

the outlet of the compressor is connected with the inlet of the condenser;
the outlet of the condenser is connected with the inlet of the evaporator via the expansion valve; and
the outlet of the evaporator is connected with the inlet of the compressor via the low-pressure regulating valve.

Optimally, a gas-liquid separator is arranged between the compressor and the low-pressure regulating valve.

Optimally, an oil separator is arranged between the compressor and the condenser, wherein, an oil outlet of the oil separator is connected to the compressor.

Optimally, a drying filter is arranged between the condenser and the expansion valve.

Optimally, a water cooler is arranged between the condenser and the drying filter.

Optimally, a high-pressure heat recovery tube of compressor is also arranged in the sealed chamber, wherein,

the outlet of the drying filter is also connected with one end of the high-pressure heat recovery tube of compressor; and
the other end of the high-pressure heat recovery tube of compressor is connected with the inlet of the expansion valve.

Optimally, the heating device is arranged in the sealed chamber, which is an electric heating tube.

Optimally, the sealed chamber is also arranged with a vertical spacer plate and a fan to form an air circulation loop in the sealed chamber, wherein,

one side of the vertical spacer plate is used for accommodating the ware shell, and the fan is arranged above the side of the vertical spacer; and
the other side of the vertical spacer plate is for accommodating the evaporator.

Optimally, a vacuum water tank is arranged on the bottom of the chamber body, and drain outlets are arranged on the bottom of the vacuum water tank.

Optimally, a sealing ring groove is arranged around the sealing door and an inflatable sealing ring is arranged in the sealing ring groove.

Optimally, a first filter screen and a second filter screen are arranged in proper order between the vacuum device and the chamber body.

Optimally, the air inlet of the chamber body is arranged with an external pressure equalizing solenoid valve and/or an external pressure equalizing manual ball valve.

In the present invention, the sealed chamber is dehumidified through condensation process in vacuum to make it dried gradually. As there are differences in humidity and pressure between inside and outside the ware shell due to the large humidity within, the moisture in the ware shell will defuse continuously. In vacuum, the diffusion speed of moisture is accelerated, thus greatly improving the drying speed of the ware shell, and there is no difference in drying speed will occur in vacuum due to the consistent humidity, atmosphere pressure and moisture diffusion. In addition, the present invention cools part of gas in the sealed chamber to condense the moisture in the sealed chamber, which reduces the humidity of the sealed chamber, and makes the moisture in the ware shell defuse outwards continuously to gradually dry the ware shell. In the present invention, it is possible to keep the volume of the ware shell unchanged in constant temperature, while releasing the sealed chamber into normal pressure state is able to avoid excessive drying of some part of the ware shell. The present invention is able to ensure the quality of a ware shell and realize the rapid drying of the ware shell simultaneously even if the ware shell has a complex structure.

Furthermore, the present invention provides a ware shell prepared in accordance with the aforesaid rapid drying method, wherein, the supporting layer of the ware shell has a loose spongy structure.

The supporting layer of the ware shell made with the present invention has a loose spongy structure, which greatly improves the air permeability of the ware shell, and significantly reduces the breaking coefficient of a sintered ware shell to over 800 psi (pounds per square inch), thus preparing the slurry in the best conditions for making ware shells without any disintegrants.

### BRIEF DESCRIPTION OF THE ATTACHED DRAWINGS

FIG. 1 is a flow diagram of the embodiment of the rapid drying method for ware shell in accordance with the present invention;

FIG. 2 is a structural diagram of the embodiment of the rapid drying device for ware shell in accordance with the present invention;

FIG. 3 is a structural diagram of the cooling and condensing device embodied in FIG. 2;

FIG. 4 is a diagram of the improved internal structure of the device as shown in FIG. 2;

FIG. 5 is a front structure diagram of the device as shown in FIG. 4 when the sealing door is opened; and

FIG. 6 is a structural diagram of the vacuum device and the vacuum water tank outside the sealed chamber in the embodiment of the device as shown in FIG. 4.

### DETAILED DESCRIPTION OF OPERATION

In order to solve the problem that the current ware shell drying methods cannot ensure the quality of a ware shell and realize the rapid drying of the ware shell simultaneously when the ware shell has a complex structure, this invention provides a rapid drying method and device for ware shell and the ware shell, which will be described herein below in detail with figures.

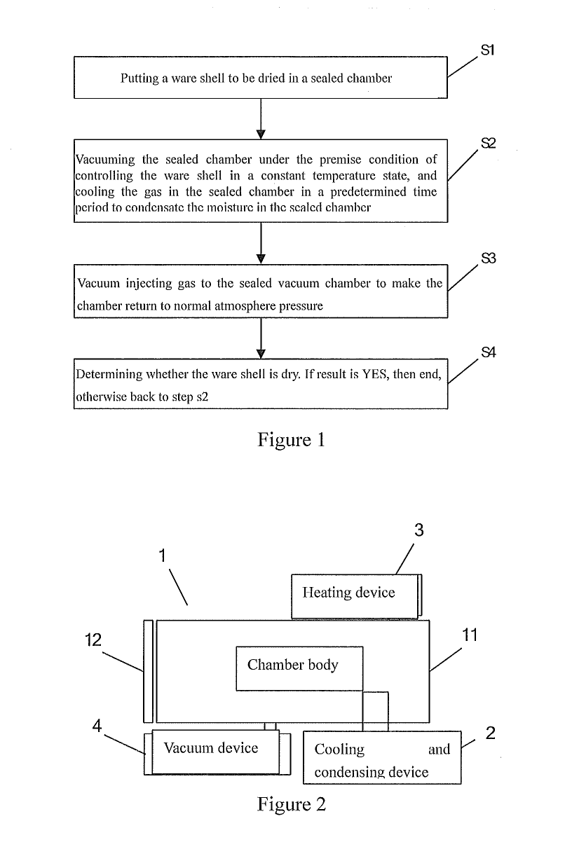

The present invention provides a rapid drying method for ware shell, as shown in FIG. 1, comprising:

S1: putting a ware shell to be dried in a sealed chamber which is preferably made of metal materials;
S2: vacuuming the sealed chamber under the premise condition of controlling the ware shell in a constant temperature state, and cooling the gas in the sealed chamber in a predetermined time period to condensate the moisture in the sealed chamber;

In this step, the quality of ware shell could be ensured by controlling the ware shell in thermostatic condition. Without controlling the temperature, volatilization of moisture will absorb heat inside the ware shell, cooling the wax pattern, and further making it contract according to the rationale of “expansion caused by heat and contraction caused by cold”, so the slurry for making the ware shell will shrink in volume accordingly. When the ware shell is completely dried, without moisture to volatilize, the wax pattern will absorb external heat and heat up to the room temperature, with its volume expanded to the original. However, since the ware shell has become dry and hard, it will inevitably burst due to the expansion of the wax pattern, or the character grooves on it might be broken due to the pulling force, thus lowering the quality of the ware shell.

In this step, vacuuming the sealed chamber and cooling part of gas in the sealed chamber may be carried out simultaneously. As there are some differences in humidity and pressure between inside and outside the ware shell due to large humidity of the ware shell, the moisture of the ware shell will defuse continuously. In vacuum, the diffusion of moisture will be speeded up, thus greatly improving the drying speed of the ware shell, Moreover, there is no difference in drying speed in vacuum due to the consistent humidity, atmosphere pressure and moisture diffusion. In addition, the present invention cools part of gas in the sealed chamber to condense the moisture inside, which reduces the humidity and makes the moisture in the ware shell defuse outwards continuously to gradually dry the ware shell.

S3: vacuum injecting gas to the sealed vacuum chamber to make the chamber return to normal atmosphere pressure;

Dehumidifying results of the ware shell under the vacuum and constant-pressure state are not as good as that under dynamic vacuuming, and there are grooves of different depths on the ware shell in most cases. In order to have even drying of the grooved bottom and the surface and improve the drying efficiency, it needs to vacuum inject gas to the sealed chamber to make it return to the normal atmosphere pressure. Repeat this process several time and the moisture content on the grooved bottom and surface of the ware shell will gradually become even, thus avoiding the influence on the quality of the ware shell due to partly excessive drying.

S4: determining whether the ware shell is dry. If result is YES, then end, otherwise back to step S2.

In this step, if the ware shell is dried completely, end the process; and if otherwise, repeat step S2 and S3. Generally speaking, the ware shell can be dried completely only after repeating step S2 and S3 several times. There are many methods to determine whether the ware shell is dried, and there two examples will be given for illustration. The first method is to check the surface temperature of the ware shell in vacuum. When the humidity is lower than some value, it will indicate that the temperature of the wet ball is equal to that of the dry ball, meaning there is no water to volatilize in the ware shell, in other words, the ware shell has been dried completely. The second method is to set a resistance value based on experiences of drying ware shells, and the ware shell will be deemed dry if it reaches this value, and so end the process; if not, continue the process.

After the process from S1 to S4 is completed, even if the structure of the ware shell is complex, the present invention can ensure the quality of a ware shell, and realize the rapid drying of the ware shell simultaneously.

It is found through tests that, under vacuum state, the slurry for making the ware shell will bloat and become spongy, and the higher the vacuum degree, the more serious the bloating. After many researches, the inventor found the reason for this phenomenon: under vacuum state, the bubble in the slurry will expand, driving the slurry and sand particles to move slightly. After a while, the expansion of the slurry ends and it stars to shrink. As the shrinking force is far smaller that the force generated by expansion, and gelled slurry and sand particles no longer have mobility to return to the previous position due to the dehydration of the slurry, the ware shell will have tiny holes and networked cracks, resulting in slightly loose tissue, increasing its thickness and air permeability.

The aforesaid phenomenon increases the air permeability and collapsibility of the ware shell, but reduces the strength. Therefore, when processing various layers of the ware shell, it is necessary to control different vacuum degrees according to different demands for the air permeability and strength of different layers.

As for the surface layer, in order to ensure the quality of the ware shell, it is required to get a dense surface layer, and avoid spongy bloating, thus, the processing of the surface layer should be carried out in low vacuum, and the vacuum degree of the sealed chamber could vary between 650˜550 mmHg, and preferably, 600 mmHg.

As the transition layer is to connect the surface layer and the supporting layer, it needs to have certain strength and air permeability. Therefore, the vacuum degree required for this layer is slightly larger than that for the surface layer, which may be 530˜430 mmHg, and preferably, 500 mmHg.

As for the supporting layer of the ware shell, it needs both enough strength to bear the static pressure of the metal liquid that has not yet solidified, and good air permeability to ensure the quality of castings. Therefore, the vacuum degree required for this layer is preferably 430˜330 mmHg. If it is kept for a period of time under said vacuum, its slurry will show a loose spongy structure, which greatly improves the air permeability and significantly reduces the breaking coefficient of the sintered ware shell to over 800 psi, thus preparing the slurry in the best conditions for making ware shells without any disintegrants.

Finally, as for the sealing layer of the ware shell, the vacuum degree required may be 430˜330 mmHg to ensure proper strength and air permeability of the layer. Drying the ware shell with the invented method as described is able to greatly reduce the time required for drying, with detailed data as shown in Table 1 below.

TABLE 1

| | Time required | | Time required by | |
|---|---|---|---|---|
| Layer of ware shell | by the natural drying | | the method adopted | |
| to be dried | method in previous arts | | in the present invention | |
| Surface layer | 8~24 | hours | 8~18 | min |
| Transition layer | 6~24 | hours | 20~40 | min |
| Supporting layer | 8~24 | hours/layer | 40~60 | min/layer |
| Sealing layer | 16~32 | hours | 40~60 | min |

As shown in Table 1, for a ware shell of 6˜8 layers, it needs about one week for natural drying in the previous arts, but only 6 hours with the method as described in the present invention, which greatly improves production efficiency, reduces costs and saves energy.

In the rapid drying method for ware shell in accordance with the present invention, the drying of the ware shell is continuously accelerated through repeatedly vacuuming and gas injecting, and a cooling, condensing and dehumidifying device is arranged inside the sealed chamber to avoid heavy moisture inside which slows the drying. In addition, a heating device is also arranged to ensure the quality of ware shell. Furthermore, the present invention uses different vacuum degrees for different layers of the ware shell to create the best conditions for drying the ware shell. Without uneven drying between the windward and leeward sides of the ware shell during the dehumidification when using a blower and difficulties in dehumidification when using hygroscopic materials, the present invention, to a certain extent, realizes the improvement in quality and rapid drying of the ware shell, thereby enhancing productivity, reducing costs, saving energy and protecting the environment.

Corresponding to the above-mentioned rapid drying method for ware shell, the present invention also provides a rapid drying device for ware shell, as shown in FIG. 2, which comprises:

a sealed chamber 1, which is used for accommodating the ware shell to be dried, and comprises a chamber body 11 which is equipped with a sealing door 12 and an air inlet (not indicated in the figure);
a heating device 3, which is used for controlling the ware shell under constant temperature;
a vacuum device 4, which is connected with the sealed chamber 1 for vacuuming the sealed chamber 1; and
a cooling and condensing device 2, which is for cooling part of gas in the sealed chamber 1, so as to condense the moisture in the sealed chamber 1.

The device as described in the present invention shall be used with the aforesaid rapid drying method for ware shell. First, place the ware shell to be dried into a sealed chamber 1; then, control the ware shell in constant temperature with the heating device 3, vacuum the sealed chamber 1 with the vacuum device 4 and cool part of gas in the sealed chamber with the cooling and condensing device 2 in predetermined time to condense the moisture in the sealed chamber 1; subsequently, inject gas into the sealed chamber 1 to make it return to normal atmosphere pressure; and finally, determine whether the ware shell is dried, if so, end the process; and if otherwise, repeat the process of vacuuming, cooling, condensing and gas injecting.

In the present invention, the sealed chamber is dehumidified through condensation process in vacuum to make it dried gradually. As there are differences in humidity and atmosphere pressure between inside and outside due to large humidity in the ware shell, the moisture in the ware shell will defuse continuously. In vacuum, the diffusion of moisture is speeded up, greatly improving the drying speed of the ware shell, and there is no difference in drying speed in vacuum due to the consistent humidity, atmosphere pressure and moisture diffusion. In addition, the present invention cools part of gas in the sealed chamber to condense the moisture in the sealed chamber, which reduces the humidity of the sealed chamber, and makes the moisture of the ware shell defuse outwards continuously to gradually dry the ware shell. In the present invention, the constant temperature keeps the volume of the ware shell unchanged; injecting gas into the sealed chamber to make it back to normal atmosphere pressure could avoid partly excessive drying of the ware shell. The present invention is able to ensure the quality of a ware shell and realize the rapid drying of the ware shell simultaneously even if the ware shell has a complex structure.

In the present invention, the cooling and condensing device 2 preferably adopts the following proposal:

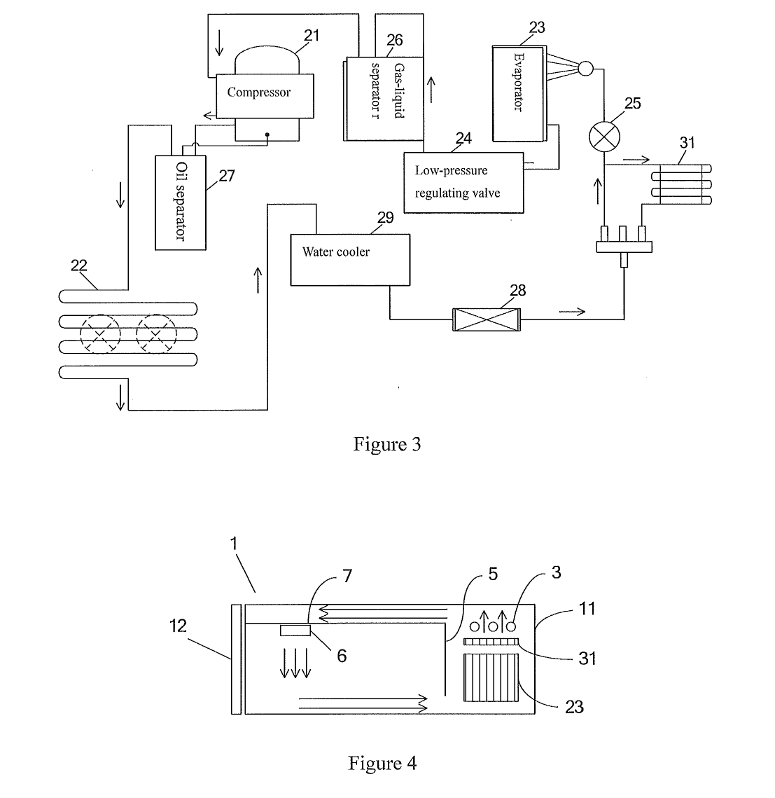

As shown in FIG. 3, the cooling and condensing device 2 comprises a compressor 21, a condenser 22, an evaporator 23, a low-pressure regulating valve 24 and an expansion valve 25. The compressor 21, the condenser 22, the low-pressure regulating valve 24 and the expansion valve 25 are all arranged outside the sealed chamber 1, and the evaporator 23 is arranged inside the sealed chamber 1, wherein,

the outlet of the compressor 21 is connected with the inlet of the condenser 22;
the outlet of the condenser 22 is connected with the inlet of the evaporator 23 via the expansion valve 25; and
the outlet of the evaporator 23 is connected with the inlet of the compressor 21 via the low-pressure regulating valve 24.

When in use, the compressor 21 first delivers the compressed gaseous cold medium to the condenser 22 under high pressure, and the condenser 22 cools down the gaseous cold medium into liquid and delivers the high-pressure liquid cold medium to the evaporator 23 via the expansion valve 25; the cold medium in the evaporator 23 absorbs the heat in the sealed chamber to condense the moisture inside, and, at the same time, it changes into low-pressure gaseous state from high-pressure liquid state, and then flows back to the compressor 21 via the low-pressure regulating valve 24, to state the next circulation.

In the aforesaid embodiment, after flowing out of the evaporator 23, the cold medium may be both in liquid and gas, therefore, for protecting the compressor 21 against damage, a gas-liquid separator 26 may be arranged between the compressor 21 and the low-pressure adjusting valve 24 for separating the liquid from the cold medium in order to make the gaseous cold medium flows back to the compressor 21 for the next circulation. The separated liquid cold medium can be delivered again to the evaporator 23 for use.

At the same time, oily substances for dissolving the cold medium may exist in the circulating pipe of the cooling and condensing device 2. For recycling the oily substances, an oil separator 27 may be arranged between the compressor 21 and the condenser 22, with its oil outlet connected to the compressor 21. In addition, for filtering the impurities in the cold medium and improving the cooling and condensing efficiency, a drying filter 28 for filtering the cold medium may also be connected between the condenser 22 and the expansion valve 25.

In order to further improve the cooling effects of the gaseous cold medium, a water cooler 29 for secondary cooling of the cold medium may be arranged between the condenser 22 and the drying filter 28, to improve the cooling and condensing effects of the whole cooling and condensing device 2.

In the process of controlling the ware shell under thermostatic condition, in order to improve the utilization of heat and save energy, a high-pressure heat recovery tube of compressor 31 is also arranged in the sealed chamber 1, wherein,

the outlet of the drying filter 28 is also connected with one end of the high-pressure heat recovery tube of compressor 31; and
the other end of the high-pressure heat recovery tube of compressor 31 is connected with the inlet of the expansion valve 25.

In this way, part of heat emitted by the compressor's high-pressure cold medium may be recycled, thus saving the energy.

As shown in FIG. 2, the heating device 3 in the present invention is used for controlling the ware shell under thermostatic condition, which may adopt various heating methods, such as infrared heating, and various layouts, such as being arranged at the exterior surface of the sealed chamber 1. However, in consideration of the heating speed and the convenience of temperature control, the heating device 3 is preferably arranged inside the sealed chamber 1, which is preferably an electric heating tube.

In the present invention, when drying the ware shell, on one hand, it is required to control the ware shell under thermostatic condition (needing to be heated); and on the other hand, it is required to cool part of gas in the sealed chamber. Therefore, to make sure of no mutual interference, and improve the drying efficiency of the ware shell, in the embodiment as shown in FIG. 4 of the present invention, the sealed chamber 1 is also arranged with a vertical spacer plate 5 and a fan 6 which form an air circulation loop in the sealed chamber 1, wherein,

one side of the vertical spacer plate 5 (the left side in FIG. 4) is used for accommodating the ware shell, and the fan 6 is arranged above the side of the vertical spacer 5; and
the other side of the vertical spacer plate 5 (the right side in FIG. 4) is for accommodating the evaporator 23.

In this way, driven by the fan 5, the air will carry the moisture in the ware shell to the evaporator 23, and then flow back to the fan 5 for the next circulation after the moisture is condensed by the evaporator 23. In order to further improve the air circulation efficiency, a transverse spacer plate 7 may be arranged above the vertical spacer plate 5 to form a L-shape structure with the vertical spacer plate 5, and the fan may be fixed on the transverse spacer plate 7, which contributes to further driving the flow direction of air and improving the air circulating efficiency. In addition, as shown in FIG. 4, in order to control the ware shell under thermostatic condition, the heating device 3 (such as electric heating tube) and the high-pressure heat recovery tube of compressor 31 may be arranged at the same side with the evaporator 23 (above the evaporator 23).

In the present invention, as the moisture in the sealed chamber 1 is condensed, the water from condensation will gather at the bottom of the sealed chamber 1. For the convenience of water drainage, as shown in FIG. 6, a vacuum water tank 8 is arranged on the bottom of the chamber body 11, and drain outlets 9 are arranged on the bottom of the vacuum water tank 8. In this way, when the ware shell is dried, water generated in drying process may be conveniently drained outwards via the vacuum water tank 8.

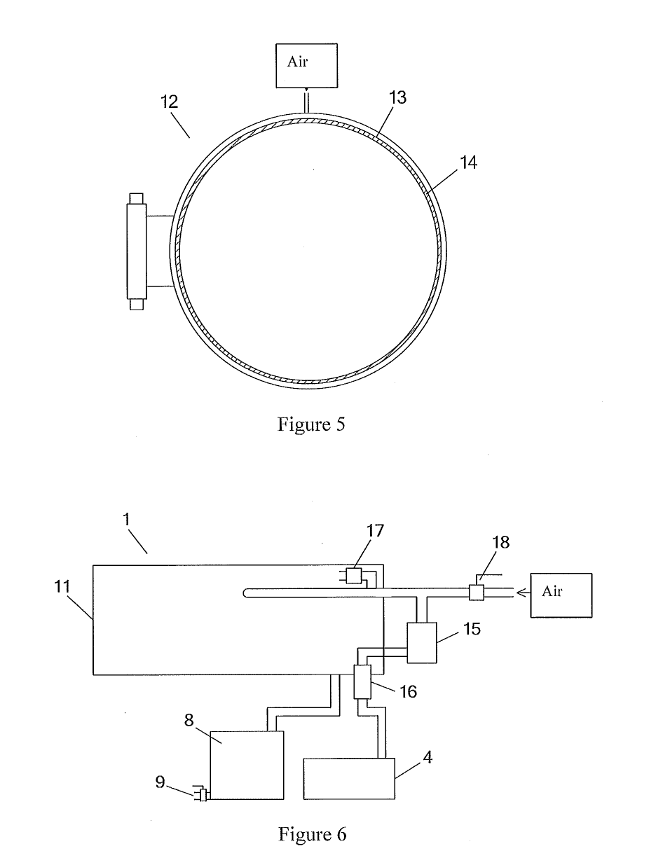

In the present invention, the sealing method of the sealing door is also slightly different from that in the previous art. As shown in FIG. 5, a sealing ring groove 13 is arranged around the sealing door 12 and an inflatable sealing ring 14 is arranged in the sealing ring groove 13. When in use, after closing the sealing door 12, fill the high-pressure gas into the inflatable sealing ring 14 to blow it up for sealing; when completing the drying, release the gas in the sealing ring 14. The sealing ring in the prior art is generally a gasket, which will have friction with the chamber body, thus influencing the service life of the sealing ring, while, the inflatable sealing ring adopted in the present invention is able to reduce the friction between the sealing ring and the chamber body, thus greatly lengthening the service life of the sealing ring.

The vacuum device 4 in the present invention is used for vacuuming the sealed chamber 1, which may be a vacuum pump commonly used in the prior art. In order to prevent impurities in the air from influencing the service life of the vacuum device 4 after entering it, as shown in FIG. 6, a first filter screen 15 and a second filter screen 16 are arranged in proper order between the vacuum device 4 and the chamber body 11 for thoroughly filtering the impurities in the air.

In addition, in the process of drying the ware shell and after completing the drying, it is required to inject gas into the sealed chamber 1 in vacuum to make it back to normal atmosphere pressure. Therefore, the air inlet of the chamber body 11 is also arranged with an external pressure equalizing solenoid valve 17 and/or an external pressure equalizing manual ball valve 18, both of which are able to make the external air return to the sealed chamber 1. In case of failure of the external pressure equalizing solenoid valve 17, the present invention may realize manual adjustment by using of the external pressure equalizing manual ball valve 18, so that the atmosphere pressure within the sealed chamber 1 could equal the external environment.

The above descriptions are only preferred embodiments of the present invention, which is not intended to limit the operation scope of the present invention. Various modifications or equivalents to the present invention, if within the spirit or scope of the present invention, should be all included in the scope of protection as claimed by the present invention.

1. A rapid drying method for ware shell is comprising the following steps:
a. putting a ware shell to be dried in a sealed chamber;
b. vacuuming the sealed chamber under the premise condition of controlling the ware shell in a constant temperature state, and cooling the gas in the sealed chamber in a predetermined time period to condense the moisture in the sealed chamber;
c. vacuum injecting gas to the sealed vacuum chamber to make the chamber return to normal atmosphere pressure;
d. determining whether the ware shell is dry; and
If the result is YES, then end, otherwise return to step b.

2. The method as described in claim 1, wherein when the surface layer of the ware shell is dried, the vacuum degree of the sealed chamber in step b is 650˜550 mmHg.

3. The method as described in claim 1, wherein when the transition layer of the ware shell is dried, the vacuum degree of the sealed chamber in step b is 530˜430 mmHg.

4. The method as described in claim 1, wherein when the supporting layer of the ware shell is dried, the vacuum degree of the sealed chamber in step b is 430˜330 mmHg.

5. The method as described in claim 1, wherein when the sealing layer of the ware shell is dried, the vacuum degree of the sealed chamber in step b is 430˜330 mmHg.

6. A rapidly drying device for a ware shell, comprising:
a sealed chamber, which is used for holding the ware shell to be dried, and comprises a chamber body equipped with a sealing door and an air inlet;
a heating device, which is used for controlling the ware shell under constant temperature;
a vacuum device, which is connected with the sealed chamber for vacuuming the sealed chamber; and
a cooling and condensing device, which is for cooling part of gas in the sealed chamber to condense the moisture in the sealed chamber.

7. The device as described in claim 6, wherein the cooling and condensing device comprises a compressor, a condenser, an evaporator, a low-pressure regulating valve and an expansion valve, wherein the compressor, the condenser, the low-pressure regulating valve and the expansion valve are all arranged outside the sealed chamber, while the evaporator is located inside, and wherein, the outlet of the compressor is connected with the inlet of the condenser; the outlet of the condenser is connected with the inlet of the evaporator via the expansion valve; and the outlet of the evaporator is connected with the inlet of the compressor via the low-pressure regulating valve.

8. The device as described in claim 7, wherein a gas-liquid separator is arranged between the compressor and the low-pressure regulating valve.

9. The device as described in claim 8, wherein an oil separator is arranged between the compressor and the condenser, and wherein, an oil outlet of the oil separator is connected to the compressor.

10. The device as described in claim 9, wherein a drying filter is arranged between the condenser and the expansion valve.

11. The device as described in claim 10, wherein a water cooler is arranged between the condenser and the drying filter.

12. The device as described in claim 10, wherein a high-pressure heat recovery tube of the compressor is also arranged inside the sealed chamber, and wherein, the outlet of the drying filter is also connected with one end of the high-pressure heat recovery tube of compressor; and the other end of the high-pressure heat recovery tube of compressor is connected with the inlet of the expansion valve.

13. The device as described in claim 6, wherein the heating device comprises an electric heating tube, and is arranged in the sealed chamber.

14. The device as described in claim 7, wherein the sealed chamber is also arranged with a vertical spacer plate and a fan to form an air circulation loop in the sealed chamber, and wherein, one side of the vertical spacer plate is used for accommodating the ware shell, and the fan is arranged above the side of the vertical spacer; and the other side of the vertical spacer plate is for accommodating the evaporator.

15. The device as described in claim 6, wherein a vacuum water tank is arranged on the bottom of the chamber body, and drain outlets are arranged on the bottom of the vacuum water tank.

16. The device as described in claim 6, wherein a sealing ring groove is arranged around the sealing door and an inflatable sealing ring is arranged in the sealing ring groove.

17. The device as described in claim 6, wherein a first filter screen and a second filter screen are arranged in proper order between the vacuum device and the chamber body.

18. The device as described in claim 6, wherein the air inlet of the chamber body is arranged with an external pressure equalizing solenoid valve and/or an external pressure equalizing manual ball valve.

19. A ware shell prepared in accordance with the method described in claim 4, wherein the supporting layer of the ware shell is of loose spongy structure.
